(19) United States
(12) Patent Application Publication
(10) Pub. No.: US 2021/0024412 A1
(43) Pub. Date: Jan. 28, 2021

(54) APPARATUS AND METHOD FOR PROCESSING A GLASS SHEET

(71) Applicant: CORNING INCORPORATED, CORNING, NY (US)

(72) Inventors: JIA LIU, Painted Post, NY (US); WEIWEI LUO, Painted Post, NY (US); WE NYU SHI, Painted Post, NY (US); NAIYUE ZHOU, Painted Post, NY (US)

(21) Appl. No.: 16/753,062

(22) PCT Filed: Oct. 2, 2018
(86) PCT No.: PCT/US2018/053888

§ 371 Date: Apr. 2, 2020

Related U.S. Application Data
(60) Provisional application No. 62/568,985, filed on Oct. 6, 2017.

(51) Int. Cl. C03C 23/00; C03B 33/02; B08B 11/04; B08B 3/02

(52) U.S. Cl. CPC C03C 23/0075; C03C 23/0085; B08B 3/022; B08B 11/04; C03B 33/02

(57) ABSTRACT

Method and apparatus for processing a glass sheet having opposing, first and second major surfaces. The glass sheet is delivered to a pre-positioning station. The pre-positioning station is operated to spray a liquid onto the first major surface to stabilize the glass sheet. The stabilized glass sheet is delivered to a washing station. The washing station is operated to wash the glass sheet. The washed glass sheet is delivered to a drying station. The drying station is operated to dry the glass sheet. With some methods of the present disclosure, by stabilizing the glass sheet at the pre-positioning station immediately prior to the washing station, the likelihood of physical contact between the glass sheet and components of the washing station are minimized.

### CROSS-REFERENCE TO RELATED APPLICATION

This application claims the benefit of priority under 35 U.S.C. § 119 of U.S. Provisional Application Ser. No. 62/568,985 filed on Oct. 6, 2017, the content of which is relied upon and incorporated herein by reference in its entirety.

### BACKGROUND

### Field

The present disclosure generally relates to apparatuses and methods for processing a glass sheet. More particularly, it relates to stabilization of a glass sheet, such as a vertically oriented glass sheet, in conjunction with other processing steps, such as cleaning of the glass sheet.

### Technical Background

In a typical glass manufacturing system, various raw constituents or batch materials are introduced or “charged” into a melting furnace. The batch materials are melted to form a viscous molten material that can be flowed to a fabrication portion of the system. The viscous molten material, when cooled, forms a glass.

The manufacture of glass sheets or other glass articles by melting raw materials is known. In one such process, known as a fusion process, molten glass overflows the sides of a trough in a forming body. The separate flows then re-unite, or fuse, at the bottom of the forming body to form a continuous ribbon of glass. Separate sheets of glass are then separated (e.g., cut) from the glass ribbon. For example, with some techniques, beads can be formed at opposing edges of the glass ribbon and serve as handling surfaces for the separation (and perhaps other) processes. Where provided, the beads are subsequently separated (e.g., cut) from a remainder of the glass sheet. Fusion processes are used in glass manufacturing operations to produce thin glass sheets that are used in a variety of products including flat panel displays.

Regardless of how the glass ribbon is formed or how the glass sheets are separated from the glass ribbon, debris (e.g., glass chips and particles) are oftentimes generated during the separation (e.g., cutting) step(s). Further, environmental conditions associated with the glass ribbon and/or glass sheet forming stations may have air-borne particles from other sources. These debris and particles can land on the surface(s) of the glass sheet. Initially, these glass chips and particles are bonded to the glass sheet surface(s) via van der Walls, electrostatic, and capillary interactions, which are relatively weak. Upon aging during transportation and storage, however, much stronger covalent bonds form between the glass sheet surface and the glass chips/particles and as a result, such glass chips/particles can become extremely difficult to remove and may pose quality concerns.

In light of the above, some glass sheet production systems or lines include one or more washing station(s) and drying station(s) that clean the glass sheet shortly after the separation process(es). Conventionally, the washing station sprays water (or other liquid) onto the opposing major surfaces of the glass sheet, for example via liquid spray orifices (e.g., water bearings). To effectuate washing at both major surfaces of the glass sheet, opposing sets of liquid spray orifices are typically provided, with the sets arranged to spray liquid onto a respective one of the glass sheet's two major surfaces. In other words, a gap is established between the opposing sets of liquid spray orifices; the glass sheet passes through this gap during a washing operation. To achieve a desired level of washing, the liquid spray orifices are desirably located in close proximity to the glass sheet. Thus, the gap between the opposing sets of liquid spray orifices can be relatively small in some instances. Under circumstances where the glass sheet is less than fully supported (e.g., when the glass sheet is held in a vertical orientation by an edge gripping device), an effective thickness of the glass sheet (e.g., deviations in flatness, vibration of the glass sheet, etc.) may be greater than the size of the gap. Similar concerns can arise with respect to the drying station (in which, for example, opposing air knives are arranged to direct a stream of gas onto a corresponding one of the glass sheet's two major surfaces).

Accordingly, alternative apparatuses and methods for processing a glass sheet, for example as part of a glass sheet manufacturing process, are disclosed herein.

### SUMMARY

Some embodiments of the present disclosure relate to a method of processing a glass sheet. The glass sheet comprises or defines opposing, first and second major surfaces. The glass sheet is delivered to a pre-positioning station. The pre-positioning station is operated to spray a liquid onto the first major surface to stabilize the glass sheet. The stabilized glass sheet is delivered to a washing station. The washing station is operated to wash the glass sheet. The washed glass sheet is delivered to a drying station. The drying station is operated to dry the glass sheet. With some methods of the present disclosure, by stabilizing the glass sheet at the pre-positioning station immediately prior to the washing station, the likelihood of physical contact between the glass sheet and components of the washing station are minimized. In some embodiments, the step of operating the pre-positioning station includes directing a gas stream onto the second major face. In other embodiments, the step of operating the pre-positioning station includes the sprayed liquid maintaining the glass sheet in a vertical orientation. In other embodiments, the step of delivering the glass sheet to the pre-positioning station includes engaging an edge of the glass sheet with a gripping device and moving the gripping device toward the pre-positioning station; in related embodiments, the step of operating the pre-positioning station includes disengaging the gripping device from the glass sheet, followed by re-engaging the glass sheet with the gripping device.

Yet other embodiments of the present disclosure relate to an apparatus for processing a glass sheet. The glass sheet comprises or defines opposing, first and second major surfaces. The apparatus comprises a pre-positioning station, a washing station, and a drying station. The pre-positioning station comprises a liquid spray assembly configured to spray liquid. Further, the pre-positioning station is configured to spray a liquid onto a first major surface of the glass sheet to stabilize the glass sheet. The washing station is downstream of the pre-positioning station and is configured to wash the glass sheet. The drying station is downstream of the washing station and is configured to dry the glass sheet. With the apparatuses of the present disclosure, the washing station can comprise opposing, first and second sets of liquid dispensers, the first set of liquid dispensers being transversely separated from the second set of liquid dispensers by a gap, and the pre-positioning station is configured to reduce an effective transverse dimension of the glass sheet to a dimension less than the gap.

Yet other embodiments of the present disclosure relate to a method for making a glass sheet. The method includes forming a glass web. A glass sheet is separated from the glass web and comprises opposing first and second major surfaces. The glass sheet is delivered to a pre-positioning station. The pre-positioning station is operated to spray a liquid onto the first major surface to stabilize the glass sheet. The stabilized glass sheet is delivered to a washing station. The washing station is operated to wash the glass sheet. The washed glass sheet is delivered to a drying station. The drying station is operated to dry the glass sheet. In some embodiments, with these and other methods of the present disclosure, a glass sheet can be formed, stabilized and cleaned on an in-line basis.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate various embodiments described herein, and together with the description serve to explain the principles and operations of the claimed subject matter.

### BRIEF DESCRIPTION OF THE DRAWINGS

FIG. 1 is a schematic illustration of a glass manufacturing system in accordance with principles of the present disclosure;

FIG. 2 is a side view of handling apparatus in accordance with principles of the present disclosure and useful with the system of FIG. 1;

FIG. 3A is a simplified top plan view of a glass sheet;

FIG. 3B is an end view of the glass sheet of FIG. 3A;

FIG. 4 is a plan view of a spray bar useful with pre-positioning stations in accordance with principles of the present disclosure, for example a pre-positioning station provided with the handling apparatus of FIG. 2;

FIG. 5 is a simplified top plan view of a portion of the handling apparatus of FIG. 2, including a pre-positioning station and a portion of a washing station;

FIG. 6 is a simplified top plan view of a portion of a handling apparatus, including another pre-positioning station in accordance with principles of the present disclosure;

FIG. 7 is a side view of a glass sheet and illustrated possible deviations from an expected thickness;

FIG. 8 is a flow chart illustrating exemplary steps of processing a glass sheet in accordance with principles of the present disclosure;

FIG. 9A-9G are simplified side views of a pre-positioning station performing steps associated with the method of FIG. 8;

FIG. 10 is a plot of lateral spacing vs. applied force between a liquid spray apparatus of a pre-positioning station of the present disclosure and a glass sheet;

FIG. 11 is a schematic perspective view of a washing station and a drying station useful with the system of FIG. 1;

FIG. 12 is a simplified top view of a handling apparatus in accordance with principles of the present disclosure processing a glass sheet;

FIG. 13 is a schematic view of a portion of a glass manufacturing system in accordance with principles of the present disclosure; and

FIG. 14 is a side view of a pre-positioning station.

### DETAILED DESCRIPTION

Reference will now be made in detail to various embodiments of apparatuses and methods for processing a glass sheet and glass sheet manufacturing operations. Whenever possible, the same reference numerals will be used throughout the drawings to refer to the same or like parts. However, this disclosure may be embodied in many different forms and should not be construed as being limited to the embodiments set forth herein.

Glass sheets are commonly fabricated forming a glass ribbon with a glass ribbon forming apparatus, separating a glass sheet from the glass ribbon by a separating apparatus, and cleaning the separated glass sheet by a handling apparatus. Glass ribbons are commonly fabricated by flowing molten glass to a forming body whereby a glass ribbon may be formed by a variety of ribbon forming processes including float, slot draw, down-draw, fusion down-draw, up-draw, or any other forming processes. The glass ribbon from any of these processes may then be subsequently divided to provide one or more glass sheets suitable for further processing into a desired application including, but not limited to, a display application. For example, the one or more glass sheets can be used in a variety of display applications including liquid crystal displays (LCDs), electrophoretic displays (EPD), organic light emitting diode displays (OLEDs), plasma display panels (PDPs), or the like. Glass sheets may be transported from one location to another. The glass sheets may be transported with a conventional support frame designed to secure a stack of glass sheets in place. Moreover, interleaf material can be placed between each adjacent glass sheet to help prevent contact between, and therefore preserve, the pristine surfaces of the glass sheets.

It is to be understood that specific embodiments disclosed herein are intended to be exemplary and therefore non-limiting. As such, the present disclosure relates to methods and apparatus for processing at least one of a glass ribbon and a glass sheet. In some embodiments, the glass ribbon to be processed can be formed from a glass manufacturing apparatus, can be provided as it is being formed from a glass manufacturing apparatus, can be provided from a spool of previously-formed glass ribbon that can be uncoiled from the spool, or can be provided as a freestanding glass ribbon. In some embodiments, the glass sheet to be processed can be formed by a glass manufacturing apparatus, can be provided as a glass sheet separated from a glass ribbon, can be provided as a glass sheet separated from another glass sheet, can be provided as a glass sheet uncoiled from a spool of glass sheets, can be provided as a glass sheet obtained from a stack of glass sheets, or can be provided as a freestanding glass sheet.

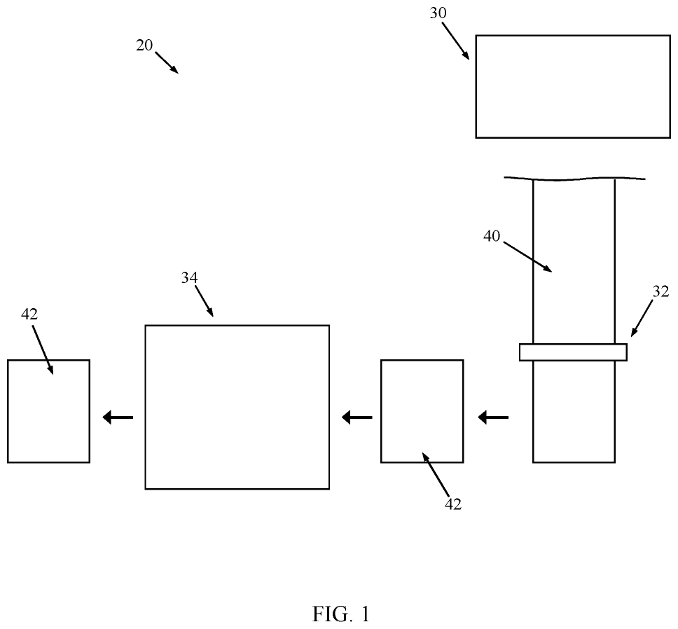

FIG. 1 generally depicts a glass manufacturing system 20 of the present disclosure. The glass manufacturing system includes a glass web or ribbon forming apparatus 30, a separation apparatus 32, and a handling apparatus 34. The glass web forming apparatus 30 generates a glass web 40 (e.g., glass ribbon), and the separation apparatus 32 operates to divide or separated individual glass sheets 42 from the glass web 40. The glass sheets 42 are delivered to the handling apparatus 34 and are cleaned (e.g., washed and dried). The glass sheets 42 can be subjected to other processes following processing by the handling apparatus 34 (e.g., coating, storage, shipping, etc.). Aspects of the present disclosure relate to features of the handling apparatus 34 and methods performed thereby. Thus, the glass web forming apparatus 30 and the separation apparatus 32 can assume a wide variety of forms, some non-limiting examples of which are described below.

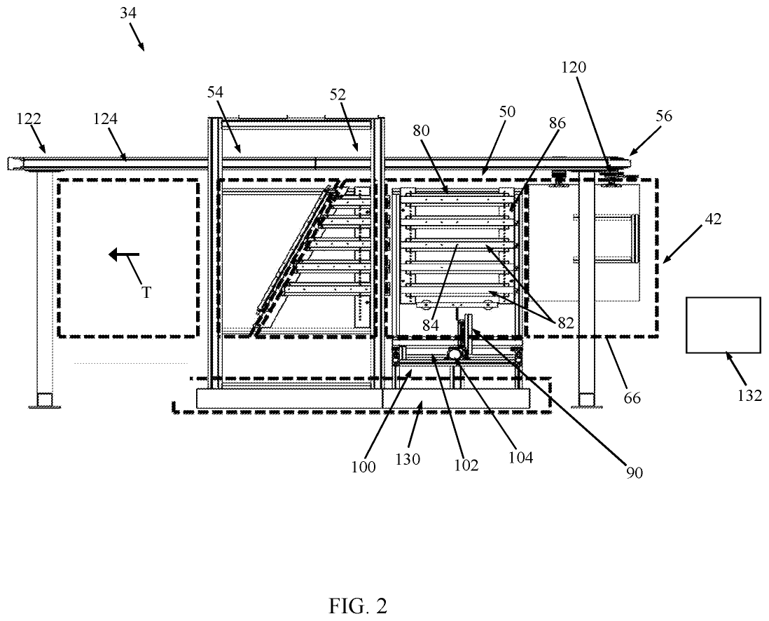

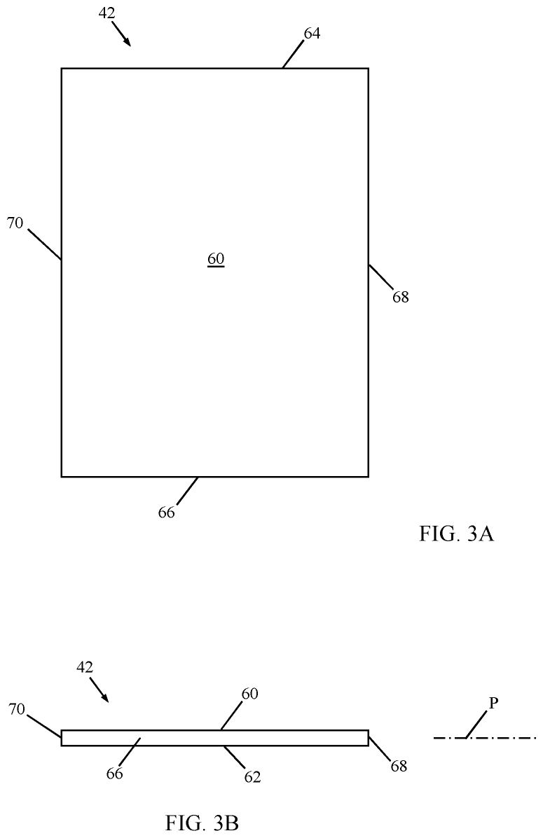

One embodiment of the handling apparatus 34 is shown in greater detail in FIG. 2. The handling apparatus 34 includes a pre-positioning station 50, a washing station 52, a drying station 54, and an optional conveyor device 56. Details on the various components are provided below. In general terms, the handling apparatus 34 is configured to process the glass sheet 42 (e.g., continuously process a series of individual glass sheets 42), such as by cleaning opposing major surfaces of the glass sheet 42. As a point of reference, FIG. 3A and 3B are simplified front and side views of an exemplary glass sheet 42. The glass sheet 42 forms or defines opposing, first and second major surfaces 60, 62 that are interconnecting by perimeter edges, such as edges 64, 66, 68, 70 (it being understood that the glass sheets of the present disclosure can have more or less than four perimeter edges). The edges 64, 66, 68, 70 can be straight or perpendicular to the major surfaces 60, 62 as shown; alternatively, one or more of the edges 64, 66, 68, 70 can be arranged at other angles relative to the one or both of the major surfaces 60, 62, can be curved or chamfered, etc. Regardless, a shape of the glass sheet 42 generates a major plane P, and one or both of the major surfaces 60, 62 are substantially parallel (i.e., within 5 degrees of a truly parallel relationship) with the major plane P. With these definitions in mind and returning to FIG. 2, the handling apparatus 34 is configured to process the glass sheet 42 in a substantially vertical arrangement (e.g., the major plane P of the glass sheet 42 is substantially vertical (i.e., within 5 degrees of a truly vertical orientation)), washing (at the washing station 52) and drying (at the drying station 54) both of the first and second major surfaces 60, 62 (the second major surface 62 being visible in the view of FIG. 2). The pre-positioning station 50 operates to stabilize the glass sheet 42 prior to delivery (and processing by) the washing station 52. The glass sheet 42 travels from the pre-positioning station 50 to the washing station 52 in a travel direction T. The conveyor device 56, where provided, is configured to at least one of deliver the glass sheet 42 to the pre-positioning station 50, transport the glass sheet 42 from the pre-positioning station 50 to and through the washing station 52 (e.g., in the travel direction T), and transport the glass sheet 42 from the washing station 52 to and through the drying station 54 (e.g., in the travel direction T).

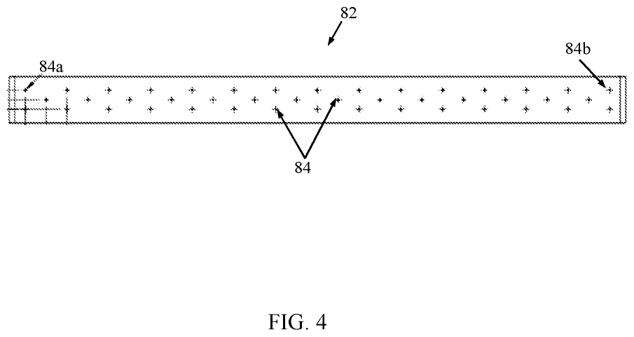

The pre-positioning station 50 includes a liquid spray assembly 80 that is configured and arranged to spray a liquid onto the first major surface 60 (FIG. 3B) of the glass sheet 42 being processed. The liquid spray assembly 80 can assume a variety of forms, and in some embodiments can be akin to a water spray or bearing device. For example, the liquid spray assembly 80 can include one or more tubes or bars 82 that each form a channel (not shown) and forming or carrying a plurality of orifices 84 (referenced generally in FIG. 2) in fluid communication with the channel. One non-limiting example of the bar 82 is shown in greater detail in FIG. 4. As illustrated, the orifices 84 can be arranged in a repeating pattern across a length of the bar 82, although other arrangements are also acceptable. A length of the bar 82 (and thus a longitudinal distance between outermost orifices 84a, 84b) is selected in accordance with an expected dimension of glass sheets to be processed by the pre-positioning station 50 (e.g., the longitudinal distance between the outermost orifices 84a, 84b approximates or is greater than the expected dimension), and in some embodiments can be on the order of 650 mm, although other dimensions, either greater or lesser, are equally acceptable. In some embodiments, one or more of the orifices 84 can be a nozzle; alternatively, a nozzle can be assembled to or carried by the bar 82 and in fluid communication with a corresponding one of the orifices 84. Returning to FIG. 2, the bar(s) 82 can be carried by a frame 86 that arranges the bar(s) to be substantially horizontal (i.e., within 5 degrees of a truly horizontal arrangement) in some embodiments. With embodiments in which two or more of the bars 82 are provided and commonly carried by the frame 86, the bars 82 can be horizontally aligned, and equidistantly spaced from one another in the vertical direction in some optional embodiments. The channel (not shown) of each of the bars 82 can be commonly fluidly connected to liquid supply source (not shown) of pressurized liquid (e.g., water), or two or more separate liquid supply sources can be provided that are each fluidly connected to respective ones of the bars 82.

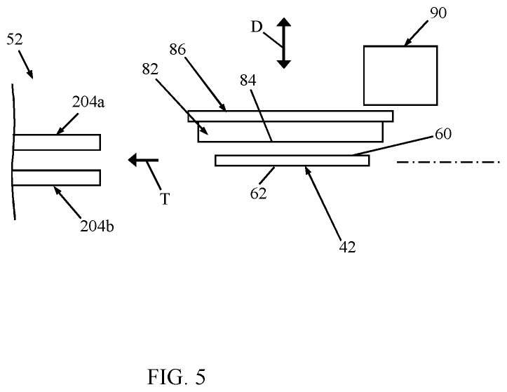

In some embodiments, the pre-positioning station 50 can optionally include an actuator device 90 connected (directly or indirectly) to the bars 82 (and in particular the orifices 84 formed or carried thereby) and operable to translate or move the orifices 84 in a direction transverse to the travel direction T. For example, FIG. 5 illustrates, in simplified form, a top view of the pre-positioning station 50 and the glass sheet 42 located within the pre-positioning station 50, along with a portion of the washing station 52. The actuator device 90 is coupled or linked to the frame 86. Connection of the actuator device 90 with the frame 86 and/or other structures (not shown) supporting the frame 86 is such that with operation of the actuator device 90, the frame 86 is caused to move in a direction D that is transverse (e.g., perpendicular) to the travel direction T. Stated otherwise, relative to the glass sheet 42 located within the pre-positioning station 50, the frame 86, and thus the bar 82, is caused to move transversely (e.g., perpendicularly) relative to the major plane P, selectively locating the orifices 84 (referenced generally) closer to, or further away from, the first major surface 60 of the glass sheet 42. The actuator device 90 can assume various forms appropriate for effectuating the transverse movements discussed above, and can, for example, include a motor or other drive device and a controller (e.g., PLC, computer, etc.) that controls operation of the actuator device 90. In other embodiments, the actuator device 90 can be omitted.

Returning to FIG. 2, the pre-positioning station 50 can optionally further include a support apparatus 100. Where provided, the support apparatus 100 includes a floor 102 and a drive device 104 (referenced generally) configured to selectively more the floor 102 in a vertical direction. The floor 102 can assume various forms, and is generally configured to contact or interface with an edge of the glass sheet 42 in a non-destructive manner. For example, the floor 102 can be formed of or coated with a material, or carries one or more bodies that are formed of or coated with a material, selected to cause minimal or no damage to a glass sheet when brought into contact with the glass sheet. The drive device 104 can assume various forms appropriate for effectuating vertical movement of the floor 102 and can, for example include a motor or other drive device and a controller (e.g., PLC, computer, etc.) that controls operation of the drive device 104. With this construction, the support apparatus 100 can be operated to selectively raise and lower the floor 102, bringing the floor 102 into and out of supportive contact with a lower edge (e.g., the edge 66 identified in FIG. 2) of the glass sheet 42 located within the pre-positioning station 50 for reasons made clear below. The support apparatus 100 can assume other forms configured to selectively support the glass sheet 42 located within the pre-positioning station 50. In other embodiments, the support apparatus 100 can be omitted.

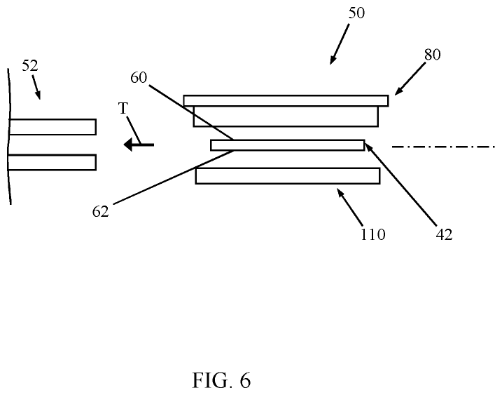

Though not shown in FIG. 2, the pre-positioning station 50 can optionally include a gas stream directing assembly located opposite the liquid spray device 80. For example, the simplified top view of FIG. 6 shows a gas stream directing assembly 110 in simplified form and relative to the liquid spray assembly 80 and the glass sheet 42 located within the pre-positioning station 50. The gas stream directing assembly 110 is configured and located to direct pressurized gas flow onto the second major surface 62 of the glass sheet 42 (it being recalled that the liquid spray device 80 is configured and located to spray liquid onto the first major surface 60). The gas stream directing assembly 110 can assume various forms, and in some embodiment can be, or can be akin to, an air knife. In other embodiments, the gas stream directing assembly 110 can include one or more nozzles in fluid communication with a source of pressurized gas (not shown), for example air, with the nozzles being distributed about an area of the pre-positioning station 50 so as to apply pressurized gas onto various regions of the glass sheet 42. In other embodiments, the gas stream directing assembly 110 can be omitted.

Returning to FIG. 2, in some embodiments, portions of the conveying device 56 and/or operation thereof can be considered part of the pre-positioning station 50 and/or performance of methods by the pre-positioning station 50. With this in mind, the conveying device 56 can include, in some embodiments, one or more gripping devices 120 and a track assembly 122. The gripping device is configured to selectively engage the glass sheet 42, such as at an edge of the glass sheet 42 (e.g., the edge 64 identified in FIG. 2), and can have a variety of forms known in the art. The gripping devices 120 are connected to a track 124 of the track assembly 122, with the track assembly 122 being operable to translate the gripping device 120 along the track 124 (e.g., the travel direction T). With this construction, the conveying device 56 is configured to maintain and transport the glass sheets 42 in the substantially vertical orientation as shown. As described in greater detail below, operation of the conveying device 56 (e.g., one or more of the gripping devices 120) can be coordinated with, or dictated by, operation of the pre-positioning station 50.

The pre-positioning station 50 can include one or more additional components. For example, a pan 130 can be provided for collecting liquid dispensed by the liquid spray device 80. Further, a controller 132 can be provided that is electronically connected to, and controls operation of, one or more of the liquid spray device 80, the actuator device 90, the support apparatus 100, the gas stream directing assembly 110, and the conveyor device 56. The controller 132 can be or can be akin to a computer, and can include a memory operating on software or hardware programmed to perform the operational steps described below. The controller 132 can optionally further be programmed to control operations of other components of the handling apparatus 34, for example components of the washing station 52 and/or the drying station 54.

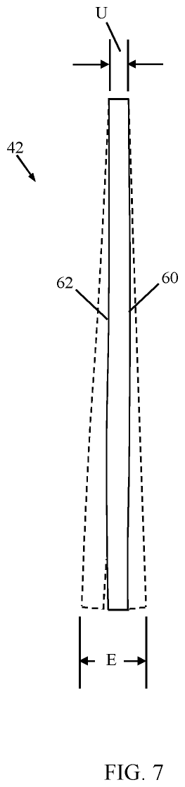

As mentioned above, the pre-positioning station 50 is configured to stabilize the glass sheet 42 prior to delivery to the washing station 52. As a point of reference, as initially provided to the pre-positioning station 50, the glass sheet 42 may exhibit deviations in flatness. For example, where the glass sheet 42 is separated from the glass ribbon 40 (FIG. 1) and relatively immediately delivered to the pre-positioning station 50 (e.g., immediately after a vertical bead separation operation at the bottom of the glass ribbon drawing operation), the glass sheet 42 may not be truly flat due, for example, to the mechanical and thermal history of the glass sheet 42. Moreover, the glass sheet 42 may be bowed. Further, operation of the conveyor device 56 (or other device utilized to deliver the glass sheet 42 to the pre-positioning station 50) may cause the glass sheet 42 to experience vibrations or other movements lateral to the travel direction T. These circumstances are generally represented by the simplified side view of FIG. 7. As shown, one or both of the major surfaces 60, 62 of the glass sheet 42 can exhibit deviations in flatness. Further, vibrations or other lateral movements/motion can be imparted onto the glass sheet 42 (represented by dashed lines). Thus, while the glass sheet 42 is expected to have a uniform thickness U (i.e., distance between the opposing major surfaces 60, 62), as provided to the pre-positioning station 50 (FIG. 2), the glass sheet 42 instead exhibits an effective transverse dimension E that is greater than the expected uniform thickness U. The pre-positioning station 50 operates to stabilize the glass sheet 42, decreasing the effective transverse dimension E to more nearly correspond with the expected uniform thickness U.

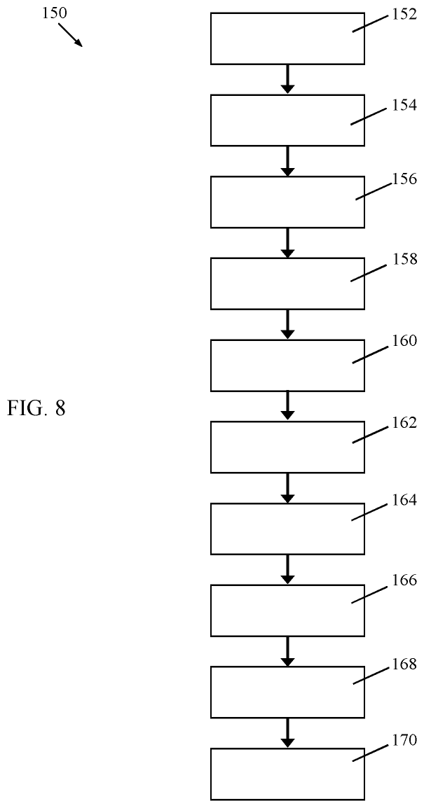

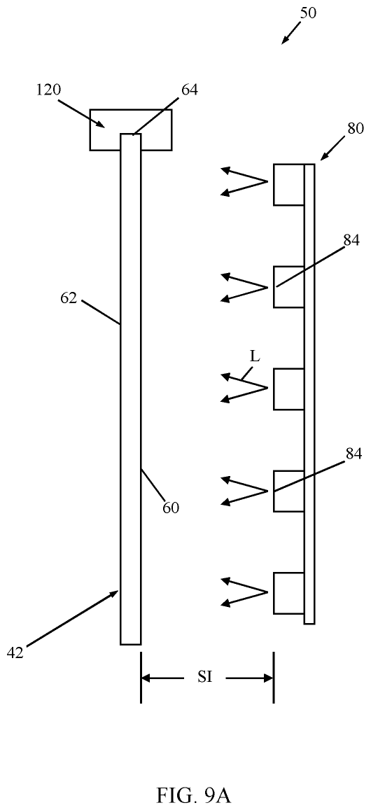

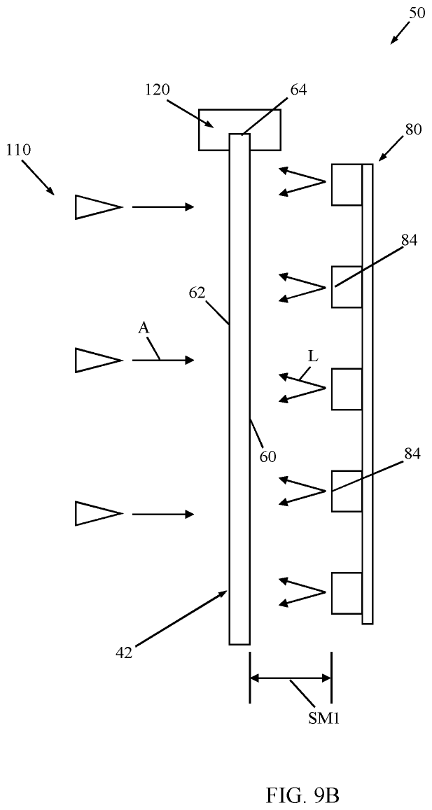

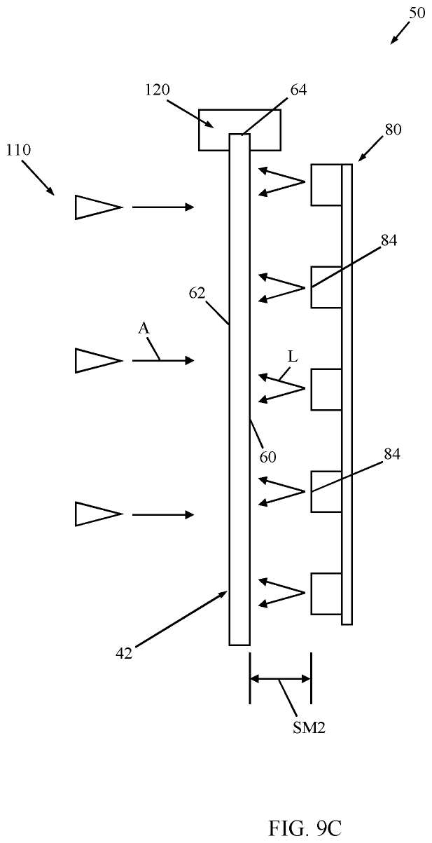

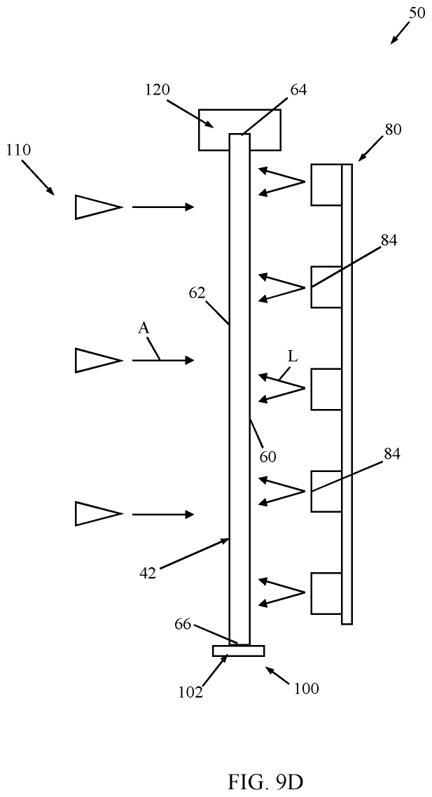

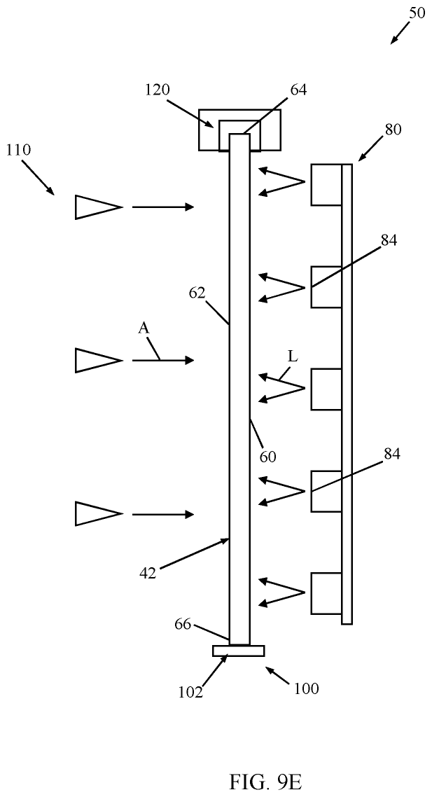

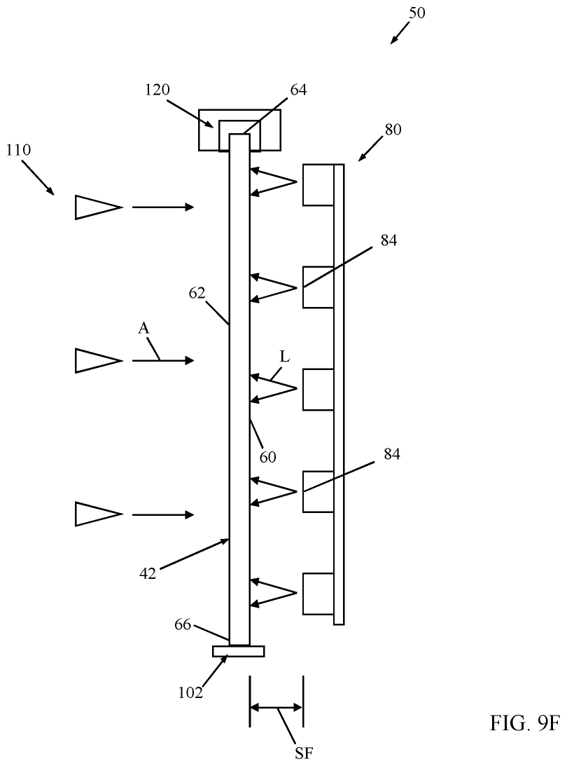

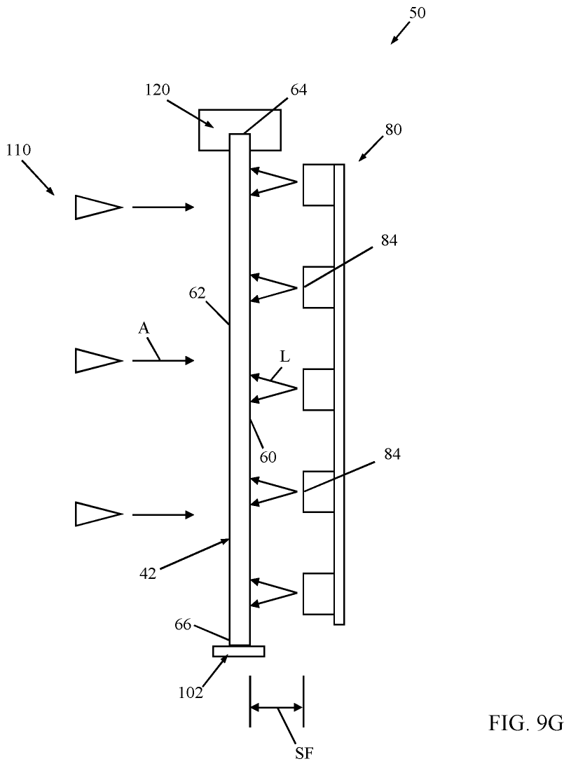

One non-limiting example of a method 150 for processing the glass sheet 42 by the pre-positioning station 50 is schematically shown in FIG. 8. Beginning at step 152, and with additional reference to FIG. 9A, the glass sheet 42 is delivered to the pre-positioning station 50. For example, the conveyor device 56 (FIG. 2) can be operated to engage the glass sheet 42 at an upper edge (e.g., the edge 64) thereof with the gripper 120. The gripper 120 is articulated to bring the glass sheet 42 into the pre-positioning station 50 and in general alignment with the liquid spray assembly 80 (e.g., the first major surface 60 of the glass sheet 42 faces the orifices 84 (referenced generally) provided with the liquid spray assembly 80. In some embodiments, the liquid spray assembly 80 can be operated to dispense or spray liquid L toward the first major surface 60 as the glass sheet 42 is delivered into the pre-positioning station 50. Regardless, at the stage of operation of FIG. 9A, the liquid spray assembly 80 is positioned relative to the glass sheet 42 to provide an initial lateral spacing SI between the orifices 84 and the first major surface 60. Further at the stage of operation of FIG. 9A, the glass sheet 42 may or may not be stationary (i.e., may or may not be caused to move in the travel direction T (FIG. 2)).

At step 154, and with additional reference to FIG. 9B, while the glass sheet 42 may or may not continue to remain stationary, the liquid spray assembly 80 is caused to move toward the first major surface 60, reducing the lateral spacing between the orifices 84 (referenced generally) and the first major surface 60 to an first intermediate lateral spacing SM1 (less than the initial lateral spacing SI (FIG. 9A)). In connection with step 154, the liquid spray assembly 80 can optionally be operated to dispense or spray liquid L toward the first major surface 60. With embodiments in which the pre-positioning station 50 includes the optional gas stream directing assembly 110, methods of the present disclosure can then optionally include step 156 at which the gas stream directing assembly 110 is operated to directing streams of pressurized gas A toward the second major surface 62. With these and related embodiments, the optional gas stream directing assembly 110 can continuously operate to direct the pressurized gas A onto the second major surface 62 throughout several of the subsequent steps described below.

At step 158 (e.g., after a short dwell time at steps 154 and/or 156), and with additional reference to FIG. 9C, while the glass sheet 42 may or may not continue to remain stationary, the liquid spray assembly 80 is caused to move toward the first major surface 60, reducing the lateral spacing between the orifices 84 (referenced generally) and the first major surface 60 to a second intermediate lateral spacing SM2 (less than the first intermediate lateral spacing SM1 (FIG. 9B)). In connection with step 158, the liquid spray assembly 80 can optionally be operated to dispense or spray liquid L toward the first major surface 60.

With additional reference to FIG. 9D, with embodiments in which the pre-positioning station 50 includes the optional support apparatus 100, methods of the present disclosure can optionally include step 160. At step 160, while the glass sheet 42 continues to remain stationary, the support apparatus 100 is operated to bring (e.g., raise) the floor 102 into contact with the edge 66 of the glass sheet 42. In this position, the support apparatus 100 serves to support the glass sheet 42 in the vertical orientation.

At step 162, and with addition reference to FIG. 9E, while the glass sheet 42 may or may not continue to remain stationary, the gripping device 120 is operated to disengage or release from the glass sheet 42. Following step 162, the glass sheet 42 remains in the vertical orientation, for example via forces applied by the liquid L, the gas A and the floor 102.

At step 164, and with additional reference to FIG. 9F, while the glass sheet 42 may or may not continue to remain stationary, the liquid spray assembly 80 is caused to move toward the first major surface 60, reducing the lateral spacing between the orifices 84 (referenced generally) and the first major surface 60 to a final lateral spacing SF (less than the second intermediate lateral spacing SM2 (FIG. 9C).

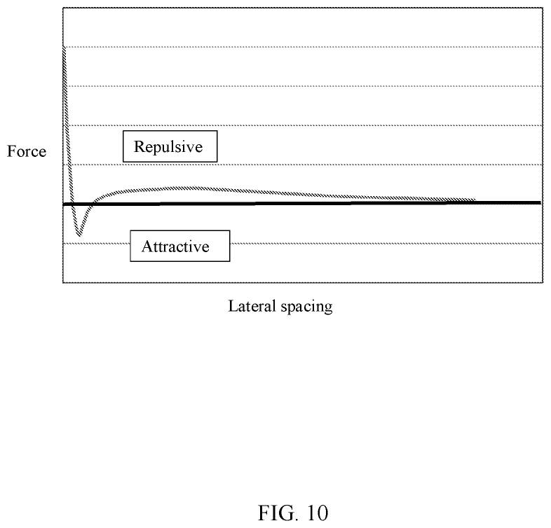

At step 166, while the glass sheet 42 may or may not continue to remain stationary, the liquid spray assembly 80 is operated to spray liquid L onto the first major surface 60. As mentioned above, the liquid spray assembly 80 can be operated to spray liquid L as part of one or more previous steps. Regardless, at step 166, and with the orifices 84 located at the final lateral spacing SF (e.g., optionally in the range of 0.1-10 mm, alternatively less than 10 mm, alternatively less than 5 mm, optionally on the order of 1 mm), the liquid spray assembly 80 sprays the liquid L onto the first major surface 60 at a flow rate appropriate for stabilizing the glass sheet 42. For example, in some non-limiting embodiments, a liquid flow rate in the range of 0.5-10 gal/min is evenly supplied across an entirety of the liquid spray assembly 80, alternatively less than 9 gal/min, alternatively less than 5 gal/min, and optionally in the range of 1-2 gal/min. Other flow rates are also envisioned. With optional embodiments including the gas stream directing assembly 110, a transverse distance between the outflow side of the gas stream directing assembly 110 (e.g., nozzles 112 in FIG. 9F) and the second major surface 62 can be in the range of 1-15 mm, alternatively less than 12 mm, alternatively less than 10 mm, and optionally on the order of 5 mm. Other distances are also acceptable. Regardless, the liquid L sprayed onto the first major surface 60 effectively serves as a water (or other liquid) bearing. In this regard, the final lateral spacing SF and liquid spray flow rate (and thus water bearing force) can be selected in tandem to support or maintain the glass sheet 42 in the vertical orientation. As a point of reference, FIG. 10 is a plot of the liquid bearing force exerted on the glass sheet 42 as a function of final lateral spacing or distance. As highlighted in the plot, at certain spray or bearing forces and distances, the glass sheet 42 experiences a net repulsive force; at other spray or bearing forces and distances, the glass sheet 42 experiences a net attractive force. By selecting an appropriate combination of flow rate/bearing force and lateral spacing, the collective liquid spray will “engage” and maintain the glass sheet 42 in the vertical orientation, effectively attenuating or removing any lateral movement or vibration. Returning to FIGS. 8 and 9F, in addition to stabilizing the glass sheet 42, the sprayed liquid L acts to flatten the glass sheet 42 by cooling. Step 166 can have a time period in the range of 15-180 seconds in some non-limiting embodiments.

With additional reference to FIG. 9G, at step 168 the gripping device 120 is operated to re-engage the glass sheet 42 (e.g., at the edge 64). At step 170, the floor 102 is withdrawn from contact with the glass sheet 42. At step 172, the glass sheet 42 is removed from the pre-positioning station 50. For example, the conveyor device 56 (FIG. 2) is operated to transport the gripping device 120 (and thus the now-engaged glass sheet 42) from the pre-positioning station 50 in the travel direction T (FIG. 2).

The methods implicated by FIG. 8 are but one example of the present disclosure. In other embodiments, for example, one or more of the steps of FIG. 8 can be omitted. Additionally or alternatively, other steps can be added. Regardless, and returning to FIG. 2, the glass sheet 42 is stabilized at the pre-positioning station 50 for delivery to the washing station 52.

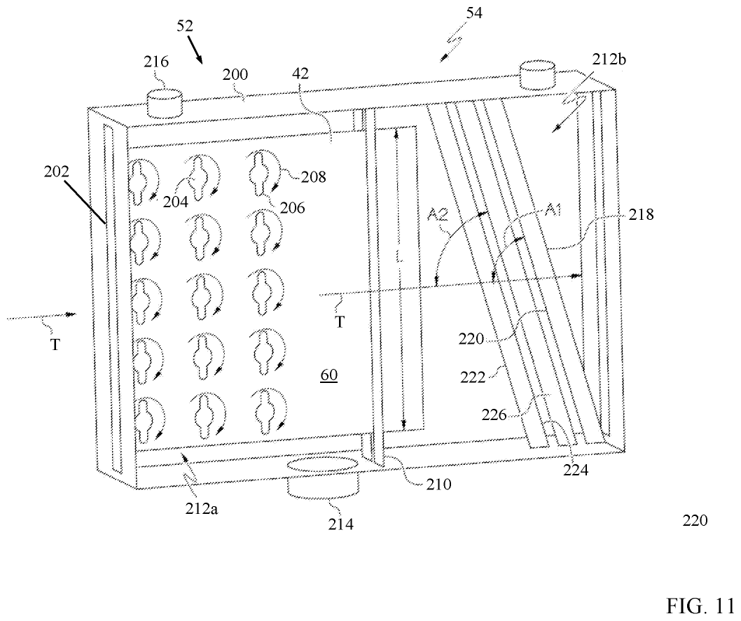

The washing station 52 and the drying station 54 can assume various forms appropriate for washing and drying the glass sheet 42, and in some embodiments can share a common housing 200. One non-limiting example of the washing station 52 and the drying station 54 is shown in FIG. 11. As indicated by the travel direction arrow T in FIG. 11, the washing station 52 can receive the glass sheet 42 relatively quickly after the glass sheet 42 has been stabilized at the pre-positioning station 50 (FIG. 2); for example, an entrance or slot 202 in the housing 200 is located in-line with an exit (not shown) from the pre-positioning station 50. In some embodiments, the glass sheet 42 can be quickly moved between the pre-positioning station 52 and the washing station 52. In some embodiments, relatively quick movement of the glass sheet 42 (represented by travel direction T) can involve a time lapse of from about 1 second to about 20 seconds, such as from about 1 second to about 15 seconds, from the time the glass sheet 42 leaves the pre-positioning station 50 until the glass sheet 42 begins being received by the washing station 52.

The washing station 52 can include the housing 200 with a first liquid dispenser 204 (e.g., a plurality of first liquid dispensers 204) including a first liquid nozzle 206 (e.g., a plurality of first liquid nozzles 206) oriented to dispense liquid against the major surfaces 60, 62 of the glass sheet 42. While not shown, an exemplary washing station 52 can dispense liquid against both the first major surface 60 of the glass sheet 42 and the second major surface 62 (FIG. 3B) of the glass sheet 42. For example, FIG. 5 reflects the washing station 52 as including opposing, first and second sets of liquid dispensers 204a, 204b; the first set 204a is positioned to direct liquid onto the first major surface 60 of the glass sheet 42, and the second set 204b is positioned to direct liquid onto the second major surface 62. Accordingly, and returning to FIG. 11, the depiction of single-sided dispensing, unless otherwise noted, should not limit the scope of the claims appended herewith as such a depiction was conducted for purposes of visual clarity. As shown, the first liquid nozzles 206 can optionally rotate about a rotational axis as indicated by rotational arrows 208. In some embodiments (not shown), the first liquid nozzles 206 can be fixed and non-rotating. Suitable nozzles can include any one or more cone nozzles, flat nozzles, solid stream nozzles, hollow cone nozzles, fine spray nozzles, oval nozzles, square nozzles, etc. In some embodiments, the nozzles can include a flow rate from about 0.25 to about 2500 gallons per minute (gpm) that operate with pressures of from about 0 psi to about 4000 psi. Other nozzle types and designs, including nozzles not explicitly disclosed herein, may be provided in some embodiments.

In some embodiments, the housing 200 can be substantially enclosed, although a side wall of FIG. 11 has been removed to reveal features in the interior of the housing 200. In some embodiments, the housing 200 can include a partition 210 dividing an interior of the housing 200 into a first area 212a (e.g., the washing station 52) and a second area 212b (e.g., the drying station 54). The second area 212b can be positioned downstream (e.g., along travel direction T) from the first area 212a. In the illustrated embodiment, the first area 212a can include the first liquid dispenser 204. A drain 214 can be provided to remove the liquid with any debris entrained in the liquid from the process of washing within the first area 212a. A vent 216 can also be provided to prevent pressure build up and to allow vapor and/or gas to escape from the first area 212a of the housing 200. As shown, exemplary embodiments can process the glass sheet 42 in a vertical orientation. Suitable mechanisms used for such vertical orientation and movement thereof can be provided by the conveyor device 56 (FIG. 2); other non-limiting examples are described in U.S. Application No. 62/066,656, filed Oct. 21, 2014, the entirety of which is incorporated herein by reference.

The drying station 54 can include a gas knife 218 positioned downstream (e.g., along the travel direction T) from the first liquid dispenser 204, such as within the second area 212b of the housing 200, as shown. The gas knife 218 can include a gas nozzle 220 (e.g., an elongated nozzle) oriented to extend along the entire length “L” of the glass sheet 42 and oriented to dispense gas against the major surfaces 60, 62 of the glass sheet 42 to remove liquid from the major surfaces 60, 62 of the glass sheet 42. The gas knife 218 may be oriented at a first angle “A1” relative to the travel direction T of the glass sheet 42 through the drying station 54. In some embodiments, the first angle “A1” can be about 90° (e.g., vertical), about 45°, from about 45° to about 90°, for example, from about 60° to about 85°, for example, from about 70° to about 80°, and all ranges and subranges therebetween. In some embodiments, the first angle “A1” can be about 135°, from about 90° to about 135°, for example, from about 95° to about 120°, for example, from about 100° to about 110°, and all ranges and subranges therebetween. The gas knife 218 can be designed to dispense gas against the major surfaces 60, 62 of the glass sheet 42 to remove liquid from the major surfaces 60, 62 of the glass sheet 42. Suitable gases include, but are not limited to, air, nitrogen, low humidity gases, and the like.

As further illustrated, the drying station 54 can optionally include a second liquid dispenser 222 including a second liquid nozzle 224 oriented to rinse the major surfaces 60, 62 of the glass sheet 42 at a location upstream (e.g., along travel direction T) from the gas knife 218. In some embodiments, the second liquid dispenser 222 can include a lower pressure liquid stream when compared to the pressure of the liquid stream generated by the first liquid dispenser 204 in the washing station 52. Indeed, the lower pressure liquid stream of the second liquid dispenser 222 can flood the major surfaces 60, 62 of the glass sheet 42 to remove any detergents, chemicals, debris, or other impurities remaining on the glass sheet 42. As shown, in some embodiments, a deflector 226 can be positioned downstream (e.g., along travel direction T) from the second liquid dispenser 222 and upstream from the gas knife 218. The deflector 226 can be oriented to direct an amount of liquid from the second liquid dispenser 222 away from the gas knife 218. As shown, the deflector 226, such as a wiper blade, may be oriented at a second angle “A2” relative to the travel direction T of the glass sheet 104. As shown, the first angle “A1” and the second angle “A2” can be substantially equal to one another; however, such a depiction, unless otherwise noted, should not limit the scope of the claims appended herewith as different angles (oblique, acute, etc. to the direction of travel) may be provided in some embodiments. Moreover, as shown, the second liquid dispenser 222 may likewise optionally include a second liquid nozzle 224 (e.g., an elongated liquid nozzle) oriented at a similar or identical angle of the deflector 226 and the gas knife 218 relative to the travel direction T of the glass sheet 42. The deflector 226 can direct liquid from the second liquid dispenser 222 downward and away from the gas knife 218, thereby reducing the amount of liquid that the gas knife 218 is required to remove from the glass sheet 42.

Although features of FIG. 11 are illustrated acting on a single one of the major surfaces 60, 62 of the glass sheet 42, it will be appreciated that similar or identical features may be provided on both sides of the glass sheet 42 to thoroughly wash and dry both the first major surface 60 of the glass sheet 42 and the second major surface 62 of the glass sheet 42. Accordingly, the left side perspective view of the washing station 52 and of the drying station 54 can be a mirror image of the right side perspective view illustrated in FIG. 11 and the above discussion and the depiction in FIG. 11 were made for purposes of visual clarity.

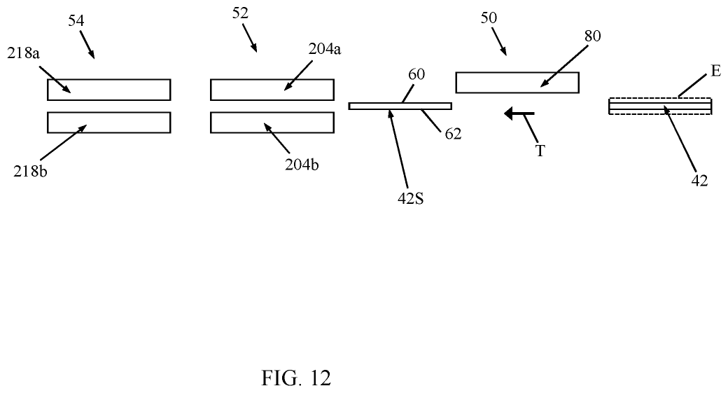

Returning to FIG. 2, the washing station 52 and the drying station 54 can each assume a wide variety of other forms apparent to one of skill in the art appropriate for washing and drying the glass sheet 42 and that may or may not be directly implicated by the explanations above (i.e., the present disclosure is in no way limited to the washing station 52 and the drying station 54 as discussed above with respect to FIG. 11). In more general terms, and as represented by the schematic top view of FIG. 12, methods of the present disclosure include the glass sheet 42 being delivered to the pre-positioning station 50. As initially presented to the pre-positioning station 50, the glass sheet 42 can exhibit the effective transverse dimension E (represented by dashed lines in FIG. 12) that is greater than the expected uniform thickness U as described above with respect to FIG. 7. The effective transverse dimension E may be greater than a gap or transverse spacing between the opposing, first and second sets of liquid dispensers 204a, 204b of the washing station 52. That is to say, were the glass sheet 42 to be delivered to the washing station 52 without processing at the pre-positioning station 50, one or both of the major surfaces 60, 62 of the glass sheet 42 may undesirably physically contact the corresponding sets of liquid dispensers 204a, 204b, possibly damaging the glass sheet 42. A similar concern would exist relative to the opposing gas knives 218a, 218b of the drying station. However, by processing the glass sheet 42 at the pre-positioning station 50 as described above (e.g., the liquid spray assembly 80 is operated to stabilize and optionally cool/flatten the glass sheet 42), as the glass sheet 42 is subsequently delivered to the washing station 52 (along the travel direction T), the glass sheet 42 is stabilized to reduce the effective transverse dimension E, approaching the effective uniform thickness U as represented by the stabilized glass sheet 42S in FIG. 12. In this stabilized condition, the glass sheet 42S readily enters the washing station 52, and is washed. In particular, both of the major surfaces 60, 62 are washed in the washing station 52, and do not come into physical contact with the corresponding sets of liquid dispensers 204a, 204b. The glass sheet 42 is then delivered (along the travel direction T) to the drying station 54. Both of the major surfaces 60, 62 are dried in the drying station 54, and do not come into physical contact with the corresponding air knives 218a, 218b. In some embodiments, the glass sheet 52 is continuously transported or conveyed through the washing and drying stations 52, 54.

Upon exiting the drying station 54, additional processes can be performed on the dried glass sheet 42. For example, in some non-limiting embodiments, a coating can be applied to the glass sheet 42 as described, for example, in PCT Publication No. WO 2017/034978, published Mar. 2, 2017, the entirety of which is incorporated herein by reference. Other processing can optionally include packaging, storage and/or shipping.

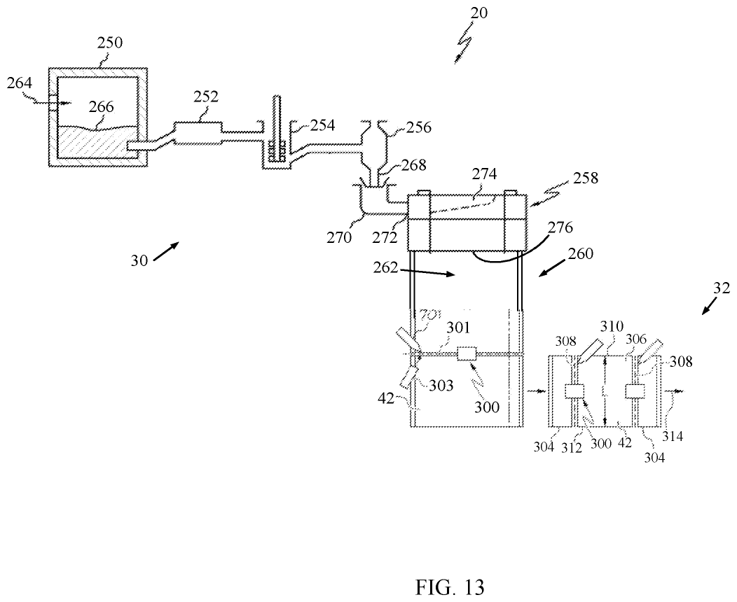

Returning to FIG. 1, as mentioned above the glass web or ribbon forming apparatus 30 and the separation apparatus 32 can assume a wide variety of forms. Some non-limiting embodiments are provided in FIG. 13. FIG. 13 generally depicts a glass manufacturing apparatus used in the production of glass in a draw operation. The glass manufacturing apparatus processes batch materials into molten glass, which is then introduced to a forming apparatus from which the molten glass flows to form a glass ribbon. While the following description is presented in the context of forming a sheet of glass in a fusion glass making process, the principles described herein are applicable to a broad range of activities where molten glass is contained within a closed or partially closed spaced and cooling of a glass ribbon generated from the molten glass is desired. The principles disclosed herein are therefore not limited by the following specific embodiments, and may be used, for example, in other glass making processes, such as float, up-draw, slot-style and Fourcault-style processes.

Referring now to FIG. 13, the glass manufacturing system 20 that incorporates the glass web forming apparatus 30 configured to perform a fusion process to produce a glass ribbon is depicted. The glass web forming apparatus 30 includes a melting vessel 250, a fining vessel 252, a mixing vessel 254, a delivery vessel 256, a forming apparatus 258, and a draw apparatus 260. The glass web forming apparatus 30 produces a continuous glass ribbon 262 from batch materials, by melting and combining the batch materials into molten glass, distributing the molten glass into a preliminary shape, applying tension to the glass ribbon 262 to control dimensions of the glass ribbon 262 as the glass cools and viscosity increases, and cutting discrete glass sheets 42 from the glass ribbon 252 after the glass has gone through a visco-elastic transition and has mechanical properties that give the glass sheets 42 stable dimensional characteristics. The visco-elastic region of the glass ribbon 262 extends from

approximately the softening point of the glass to the strain point of the glass. Below the strain point, the glass is considered to behave elastically.

In operation, batch materials for forming glass are introduced into the melting vessel 250 as indicated by arrow 264 and are melted to form molten glass 266. The molten glass 266 flows into the fining vessel 252, which is maintained at a temperature above that of the melting vessel 250. From the fining vessel 252, the molten glass 266 flows into the mixing vessel 254, where the molten glass 266 undergoes a mixing process to homogenize the molten glass 266. The molten glass 266 flows from the mixing vessel 254 to the delivery vessel 256, which delivers the molten glass 266 through a downcomer 268 to an inlet 270 and into the forming apparatus 258.

The forming apparatus 258 depicted in FIG. 13 is used in a fusion draw process to produce glass ribbon 262 that has high surface quality and low variation in thickness. The forming apparatus 258 includes an opening 272 that receives the molten glass 266. The molten glass 266 flows into a trough 274 and then overflows and runs down the sides of the trough 274 in two partial ribbon portions before fusing together below a bottom edge (root) 276 of the forming apparatus 258. The two partial ribbon portions of the still-molten glass 266 rejoin with one another (e.g., fuse) at locations below the root 276 of the forming apparatus 258, thereby forming the glass ribbon 262. The glass ribbon 262 is drawn downward from the forming apparatus 258 by the draw apparatus 260. While the forming apparatus 258 as shown and described herein implements a fusion draw process, it should be understood that other forming apparatuses may be used including, without limitation, slot draw apparatuses and the like. The draw apparatus 260 can include one or more roller assemblies (not shown) as known to those of skill in the art. The roller assemblies are arranged at positions along the draw apparatus 260 to contact the glass ribbon 262 as the glass ribbon 262 moves through the draw apparatus 260.

The separating apparatus 32 can include a glass separator 300. A variety of glass separators 300 may be provided in embodiments of the present disclosure. For example, a traveling anvil machine may be provided that can score and then break the glass ribbon 262 along the score line. In some embodiments, the glass separator 300 can include a robot (e.g., a robotic arm) oriented to bend the glass sheet 42 relative to the glass ribbon 262 to separate the glass sheet 42 from the glass ribbon 262 along a transverse separation path 301 corresponding to the score line. In some embodiments, a scribe 302 (e.g., score wheel, diamond tip, etc.) can be utilized as understood by those of ordinary skill. In some embodiments, a laser-assisted separation device 303 may be provided as described below and also in U.S. application Ser. No. 14/547,688, filed Nov. 19, 2014, the entirety of which is incorporated herein by reference. Such laser-assisted separation devices can include, but are not limited to, laser scoring techniques that heat the glass ribbon 262 and then cool the glass ribbon 262 to create a vent in the glass ribbon 262 to separate the glass ribbon 262. Such laser-assisted separation devices may also include laser cutting techniques that heat the glass ribbon 262 to produce a stressed region in the glass ribbon 262 and then apply a defect to the stressed region of the glass ribbon 262 to initiate a crack to separate the glass ribbon 262. FIG. 1 illustrates a general schematic of an exemplary glass separator 300.

In some embodiments, the separation apparatus 32 can separate an outer portion 304 of the glass sheet 42 from a central portion 306 of the glass sheet 42 along a vertical separation path 308 that extends along a length “L” between a first transverse edge 310 of the glass sheet 42 and a second transverse edge 312 of the glass sheet 42. As illustrated, such a technique can be carried out in a vertical orientation, although horizontal orientations may be provided in some embodiments. In some embodiments, a vertical orientation may facilitate the carrying away of glass particles by gravity, thereby reducing or preventing contamination of the otherwise pristine major surfaces of the glass ribbon 262.

Other optional features provided or performed by the separation apparatus 32 are described, for example, in PCT Publication No. 2017/024978, published Mar. 2, 2017, the entirety of which is incorporated herein by reference. Regardless, following processing at the separation apparatus, the glass sheet 42 is delivered (e.g., immediately delivered) to the handling apparatus 34 (FIG. 1), as indicated by arrow 314 in FIG. 13.

Embodiments and advantages of features of the present disclosure are further illustrated by the following non-limiting examples, but the particular materials, amounts, dimensions, conditions and other details thereof recited in these examples should not be construed to unduly limit the scope of the present disclosure.

### EXAMPLES

### Example 1

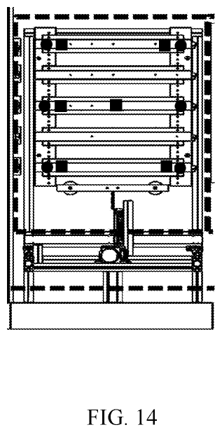

To evaluate the glass sheet stabilization apparatuses and methods of the present disclosure, a pre-positioning station akin to the pre-positioning station 50 described above with respect to FIG. 2 was created. The liquid spray assembly consisted of five horizontal and parallel water bars, with the design of a single one of the water bars shown in FIG. 4. The center-to-center distance between immediately adjacent ones of the water bars was 180 mm. Six ultrasonic sensors were mounted to the liquid spray assembly to monitor a position of a glass sheet during subsequent processing. A gas stream directing assembly was positioned opposite the liquid spray assembly and consisted of six air nozzles. A general arrangement of the pre-positioning station of the Examples section is provided in FIG. 14, with the solid circles representing the six air nozzles, and the solid squares representing the six ultrasonic position sensors.

A test glass sheet was obtained and vertically oriented between the liquid spray assembly and the gas stream directing assembly. A first major surface of the test glass sheet faced the liquid spray assembly, and the opposing, second major surface of the test glass sheet faced the gas stream directing assembly. A distance between the first major surface and the orifices of the liquid spray assembly was 1 mm. A distance between the second major surface and the tips of the nozzles of the gas stream directing device was 5 mm. The Example pre-positioning station was then operated to direct water flow onto the first major surface (via the liquid spray assembly) and air flow onto the second major surface (via the gas stream directing assembly), including with different tests being performed at different flow rates of water provided to the liquid spray assembly as described below. During all testing, a total flow rate to the gas stream directing device was 500 SLPM (distributed evenly among the six air nozzles). The glass sheet was delivered to the Example pre-positioning station at a conveyance speed of 30 m/min, and was transported from the Example pre-positioning station at a conveyance speed of 20 m/min. The position of the first major surface relative to the liquid spray assembly was recorded at each of the six ultrasonic position sensors. Testing was performed at water flow rates of 1 gal/min, 1.5 gal/min and 2 gal/min. It was visually observed that in all instances, the glass sheet never touched the liquid spray assembly, and the liquid bearing established by the liquid spray assembly was able to support the glass sheet even when the overhead grippers were released. A summary of the test results is provided in Tables 1, 2, and 3 below (all numeric values are in mm). Negative position values are reported because the position sensors were mounted on the side facing the first major face of the test glass sheet, and the reading was reset to zero when the glass sheet was manually pushed toward the gas stream directing assembly.

TABLE 1

| Mean | | | | | | | | | | |
|---|---|---|---|---|---|---|---|---|---|---|
| Value | | Water: 1 GPM | | | Water: 1.5 GPM | | | Water: 2 GPM | | |
| [mm] | | Inlet | Middle | Outlet | Inlet | Middle | Outlet | Inlet | Middle | Outlet |
| Case | Top | −0.7679 | | −0.8676 | −1.0724 | | −1.2105 | −1.7252 | | −1.6441 |
| 1 | Middle | −0.8300 | −0.2374 | | −0.9129 | −0.2996 | | −1.0254 | −0.6543 | |
| | Bottom | −0.7017 | | −0.6568 | −1.1189 | | −1.0517 | −1.1746 | | −1.5767 |
| Case | Top | −0.9758 | | −0.9939 | −1.1008 | | −1.3402 | −2.5190 | | −1.7740 |
| 2 | Middle | −0.7655 | −0.1991 | | −0.9339 | −0.4518 | | −1.0688 | −0.6298 | |
| | Bottom | −0.8848 | | −0.8203 | −0.1054 | | −1.0359 | −1.2008 | | −1.9445 |

TABLE 2

| Standard | | | | | | | | | | |
|---|---|---|---|---|---|---|---|---|---|---|
| Deviation | | Water: 1 GPM | | | Water: 1.5 GPM | | | Water: 2 GPM | | |
| [mm] | | Inlet | Middle | Outlet | Inlet | Middle | Outlet | Inlet | Middle | Outlet |
| Case | Top | 0.0788 | | 0.1378 | 0.0472 | | 0.0971 | 0.7897 | | 0.0884 |
| 1 | Middle | 0.0628 | 0.0846 | | 0.0606 | 0.0574 | | 0.0702 | 0.0614 | |
| | Bottom | 0.0420 | | 0.0232 | 0.0855 | | 0.0604 | 0.0706 | | 0.3168 |
| Case | Top | 0.0843 | | 0.1159 | 0.0766 | | 0.1297 | 1.6636 | | 0.1633 |
| 2 | Middle | 0.0407 | 0.0656 | | 0.0522 | 0.0566 | | 0.0399 | 0.0589 | |
| | Bottom | 0.0305 | | 0.0262 | 0.0398 | | 0.0491 | 0.1113 | | 0.5534 |

TABLE 3

| STD of | | | | | | |
|---|---|---|---|---|---|---|
| Outlet | | | | | | |
| Side | Water: 1 GPM | | Water: 1.5 GPM | | Water: 2 GPM | |
| [mm] | Case 1 | Case 2 | Case 1 | Case 2 | Case 1 | Case 2 |
| Top | 0.2049 | 0.2910 | 0.2751 | 0.2816 | 0.1976 | 0.1841 |
| Bottom | 0.0880 | 0.0716 | 0.0446 | 0.0651 | 0.0696 | 0.0652 |

From the results of Tables 1-3, the standard deviations were relatively small, indicating that the glass sheet was well stabilized. Among the three cases corresponding to the different water flow rates, testing performed at 1.5 gal/min resulted in the best overall sheet stability. Further increasing the flow rate to 2 gal/min offered minimal additional improvement in stability; it became difficult to engage the water bearing because the water jets impinging on the test glass sheet resulted in a large repulsive force as the water bearing approached the sheet from a greater distance, which had the tendency to push the glass sheet away.

### Example 2

Additional testing was performed using the Example pre-positioning station and testing protocols of Example 1, except that the engage position of the liquid spray assembly was offset by 1 mm towards the glass sheet undergoing testing so that the water bearing surface position coincided with a conveyor centerline position. With this arrangement, it was expected that the liquid spray assembly would come into contact with the glass sheet in the absence of liquid spray. A summary of the results of Example 2 are provided in Tables 4 and 5 below.

TABLE 4

| Mean | | | | | | | | | | |
|---|---|---|---|---|---|---|---|---|---|---|
| Distance | | Water: 1 GPM | | | Water: 1.5 GPM | | | Water: 2 GPM | | |
| [mm] | | Inlet | Middle | Outlet | Inlet | Middle | Outlet | Inlet | Middle | Outlet |
| Case | Top | −0.4601 | | −0.5446 | −0.6099 | | −0.7897 | −1.3268 | | −0.8023 |
| 1 | Middle | −0.9347 | −0.3218 | | −1.0053 | −0.4646 | | −1.1559 | −0.6186 | |
| | Bottom | −0.7585 | | −0.6647 | −0.9888 | | −0.9425 | −0.9287 | | −1.0136 |
| Case | Top | −0.4434 | | −0.5609 | −0.6676 | | −0.5919 | −4.9640 | | −0.8457 |
| 2 | Middle | −0.8829 | −0.3108 | | −1.0267 | −0.5046 | | −1.0816 | −0.6441 | |
| | Bottom | −0.7457 | | −0.6590 | −0.9427 | | −0.9154 | −0.9037 | | −2.5174 |

TABLE 5

| Standard | | | | | | | | | | |
|---|---|---|---|---|---|---|---|---|---|---|
| Deviation | | Water: 1 GPM | | | Water: 1.5 GPM | | | Water: 2 GPM | | |
| [mm] | | Inlet | Middle | Outlet | Inlet | Middle | Outlet | Inlet | Middle | Outlet |
| Case | Top | 0.0644 | | 0.1330 | 0.0777 | | 0.1079 | 1.0050 | | 0.1374 |
| 1 | Middle | 0.0498 | 0.0722 | | 0.0812 | 0.0841 | | 0.0726 | 0.0553 | |
| | Bottom | 0.0591 | | 0.0372 | 0.0725 | | 0.0589 | 0.0884 | | 0.3335 |
| Case | Top | 0.0510 | | 0.1172 | 0.0570 | | 0.1217 | 0.2344 | | 0.1252 |
| 2 | Middle | 0.0558 | 0.0527 | | 0.0755 | 0.0785 | | 0.0327 | 0.0727 | |
| | Bottom | 0.0500 | | 0.0303 | 0.0712 | | 0.0663 | 0.0444 | | 0.2317 |

From the results shown in Tables 4 and 5, the water bearing provided adequate support to the glass sheet, and glass sheet did not come into contact with the liquid spray assembly.

The handling apparatuses, processing stations, glass manufacturing systems, and methods of the present disclosure provide a marked improvement over previous designs. By stabilizing a vertically oriented glass sheet immediately prior to delivery to a washing station, the likelihood of undesirable contact between surfaces of the glass sheet and components of the washing station can be avoided, and can be done on an in-line basis. The single-sided liquid bearing with optional gas stream delivery pre-positioning stations and methods of the present disclosure offer significant process capability and flexibility to achieve the stabilizing and flattening of glass sheet. The single-sided liquid bearing can provide both repulsive and attractive forces and is inherently stable once engaged. Further, a liquid bearing (e.g., water bearing) can provide more cooling capacity (as compared to an air bearing), which can be expected to facilitate flattening of an above room temperature glass sheet.

Various modifications and variations can be made to the embodiments described herein without departing from the scope of the claimed subject matter. Thus it is intended that the specification cover the modifications and variations of the various embodiments described herein provided such modifications and variations come within the scope of the appended claims and their equivalents.

What is claimed is:

1. A method of processing a glass sheet, the glass sheet comprising opposing first and second major surfaces, the method comprising:
delivering the glass sheet to a pre-positioning station;
operating the pre-positioning station to spray a liquid onto the first major surface to stabilize the glass sheet;
delivering the stabilized glass sheet to a washing station;
washing the glass sheet;
delivering the washed glass sheet to a drying station; and
drying the glass sheet,
wherein the glass sheet defines a major plane, and further wherein the step of delivering the glass sheet to a pre-positioning station comprises orienting the glass sheet such that the major plane is substantially vertical.

2. The method of claim 1, wherein the step of delivering the glass sheet to a pre-positioning station comprises engaging the glass sheet with a gripping device.

3. The method of claim 2, wherein the step of engaging the glass sheet with a gripping device comprises gripping an edge of the glass sheet with the gripping device.

4. The method of claim 2, wherein the step of delivering the glass sheet to a pre-positioning station further comprising conveying the gripping device along a track.

5. The method of claim 4, wherein the step of operating the pre-positioning station further comprises:
disengaging the gripping device from the glass sheet;
spraying the liquid onto the first major surface to stabilize the glass sheet; and
re-engaging the glass sheet with the gripping device.

6. The method of claim 5, wherein the step of operating the pre-positioning station further comprises contacting an edge of the glass sheet with a support device prior to the step of disengaging the gripping device from the glass sheet.

7. The method of claim 6, wherein the step of operating the pre-positioning station further comprises retracting the support device from contact with the edge of the glass sheet following the step of re-engaging the glass sheet with the gripping device.

8. The method of claim 4, wherein the step of delivering the stabilized glass sheet to a washing station comprises conveying the gripping device along the track.

9. The method of claim 8, wherein the step of delivering the washed glass sheet to a drying station comprises conveying the gripping device along the track.

10. The method of claim 1, wherein the step of operating the pre-positioning station further comprises applying a gas stream onto the second major surface of the glass sheet.

11. The method of claim 1, wherein the pre-positioning station comprises a plate defining a plurality of liquid spray nozzles, and further wherein the step of operating the pre-positioning station further comprise decreasing a distance between the plate and the first major surface while continually spraying the liquid onto the first major surface.

12. The method of claim 1, wherein the liquid is water.

13. The method of claim 1, wherein the step of operating the washing station comprises spraying a liquid onto both of the first and second major surfaces.

14. An apparatus for processing a glass sheet, the glass sheet comprising opposing first and second major surfaces, the apparatus comprising:
a pre-positioning station comprising a liquid spray assembly configured to spray liquid, the pre-positioning station configured to spray a liquid onto the first major surface to stabilize the glass sheet;
a washing station downstream of the pre-positioning station, the washing station configured to wash the glass sheet; and
a drying station downstream of the washing station, the drying station configured to dry the glass sheet.

15. The apparatus of claim 14, further comprising a conveyor device configured to convey the glass sheet to the pre-positioning station, and from the pre-positioning station to the washing station, and from the washing station to the drying station.

16. The apparatus of claim 14, wherein the washing station comprises a first set of liquid dispensers and a second set of liquid dispensers, the first set of liquid dispensers being transversely separated from the second set of liquid dispensers by a gap, and further wherein the pre-positioning station is configured to reduce an effective transverse dimension of the glass sheet to a dimension less than the gap.

17. The apparatus of claim 14, wherein the pre-positioning station further comprises a gas stream directing assembly, the pre-positioning station further configured to apply a gas stream onto the second major surface of the glass sheet.

18. The apparatus of claim 14, wherein apparatus is configured to define a travel direction for the glass sheet, and further wherein the water spray assembly comprises a plate defining a plurality of liquid spray nozzles and an articulation device for moving the plate in a transverse direction relative to the travel direction.

19. A method for making a glass sheet, the method comprising:
forming a glass web;
separating a glass sheet from the glass web, the glass sheet comprising opposing first and second major surfaces;
delivering the glass sheet to a pre-positioning station;
operating the pre-positioning station to spray a liquid onto the first major surface to stabilize the glass sheet;
delivering the stabilized glass sheet to a washing station;
washing the glass sheet;
delivering the washed glass sheet to a drying station; and
drying the glass sheet.
wherein the glass sheet defines a major plane, and further wherein the step of delivering the glass sheet to a pre-positioning station comprises orienting the glass sheet such that the major plane is substantially vertical.
